(19) United States
(12) Patent Application Publication
(10) Pub. No.: US 2017/0299364 A1
(43) Pub. Date: Oct. 19, 2017

(54) Tape Measure End Piece Attachment

(71) Applicant: Darrin Carrier, Webster, MA (US)

(72) Inventor: Darrin Carrier, Webster, MA (US)

(21) Appl. No.: 15/464,880

(22) Filed: Mar. 21, 2017

Related U.S. Application Data
(60) Provisional application No. 62/312,199, filed on Mar. 23, 2016.

(51) Int. Cl. G01B 3/10

(52) U.S. Cl. CPC G01B 3/1056

(57) ABSTRACT

The present invention is a tape measure end piece attachment. The tape measure end-piece attachment is made from one piece of material, wherein the components are all continuously connected. The tape measure end piece attachment has a rounded bottom, a straight tongue with a connecting section, and a large hook. The straight tongues connecting section allows the tape measure end piece attachment to be connected to a tape measure end hook that has two raised rivets for attachments. The rounded bottom of the tape measure end piece attachment allows the end piece and the tape measure blade to travel across rough and or uneven surfaces.

The large hook of the tape measure end piece can hook onto objects to achieve a measurement at a distance or be pushed up against an object to obtain a measurement. The tape measure end piece has very limited movement once secured to a tape measure hook with raised rivets but moves back and forth the thickness of the large hook as to obtain an accurate measurement whether hooking on to an object or being pushed up against an object for a measurement.

The current application claims priority to the U.S. Provisional Patent application Ser. No. 62/312,199 filed on Mar. 23, 2016

### FIELD OF THE INVENTION

The present invention relates to end piece attachments for tape measures. In particular, the present invention relates to a device which attaches onto the blade and end hook of a tape measure, allowing the tape measure to easily traverse over uneven surfaces.

### BACKGROUND OF THE INVENTION

A tape measure is a measuring device that is similar in function to a flexible and extendable ruler. Tape measures are handheld devices used to measure great lengths, consisting of a self-retracting measuring blade which is mounted to a reel located inside a housing. End hooks or tangs are attached to the end of the blade's distal end via a loose rivet connection in order to aid with measuring. Utilizing tape measures can be a very difficult task, when used on uneven surfaces such as shingled roofs, as it is common for the end hook to snag or bounce around on course material, causing the blade to buckle.

It is therefore an objective of the present invention to introduce a tape measure end piece attachment. Some tape measures are now made with two raised rivets that attachments such as a magnet and bigger hook can be attached to. This product attaches in the same fashion but it is a better attachment than any of the existing attachments. It not only is a larger hook, but also has the ability, to allow the end of the tape measure to travel over rough or uneven surfaces that all other tape measure end hooks would get snagged on and make the tape measure blade buckle. This end piece can be removed for taking more precise measurements. The present invention comprises a round bottom which allows the device and tape measure blade to glide over uneven surfaces. Overall, the present invention is lightweight, sturdy, easy to use, safe, and effective.

### BRIEF DESCRIPTION OF THE DRAWINGS

FIG. 1 is a top-perspective view of the present invention, as described in its preferred embodiment;

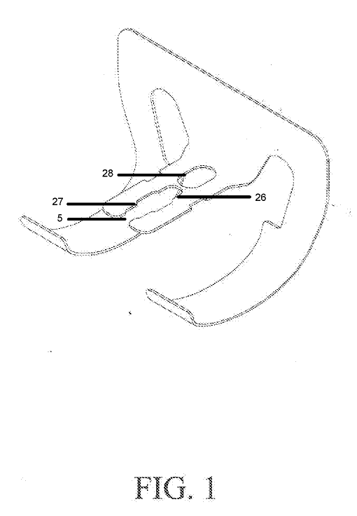

FIG. 2 is a bottom-perspective view of the present invention thereof;

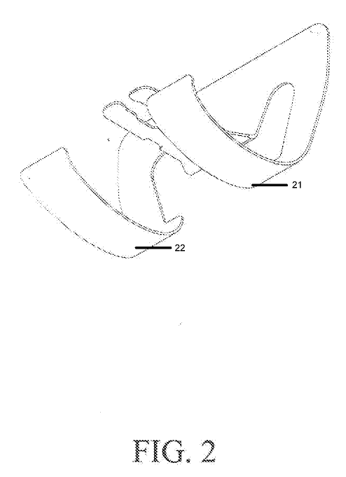

FIG. 3 is an elevated front-side view of the present invention thereof;

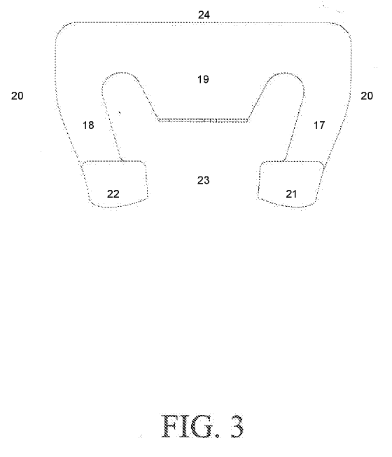

FIG. 4 is an elevated rear-side view of the present invention thereof;

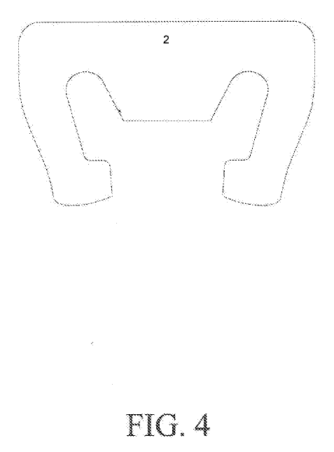

FIG. 5 is an elevated top-side view of the present invention thereof;

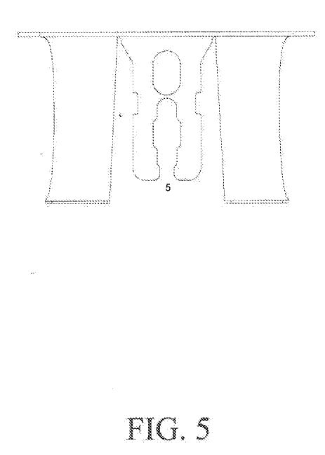

FIG. 6 is an environmental perspective view of the present invention attached onto a tape measure blade and end hook, via raised rivet connection; and

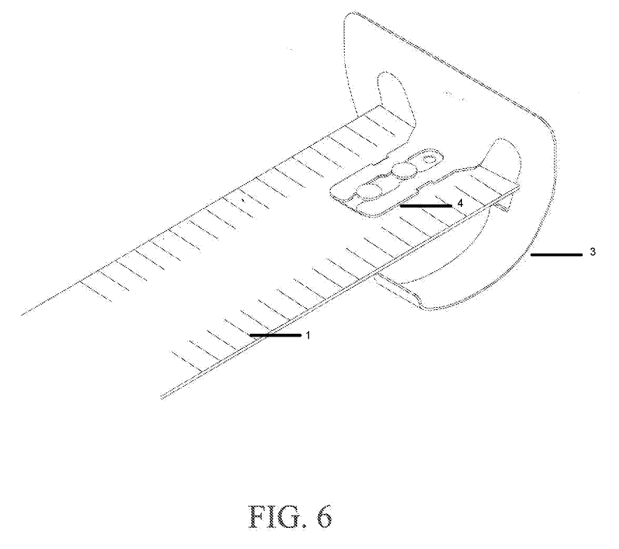

FIG. 7 is an exploded view, displaying the connection between the present invention and an end hook.

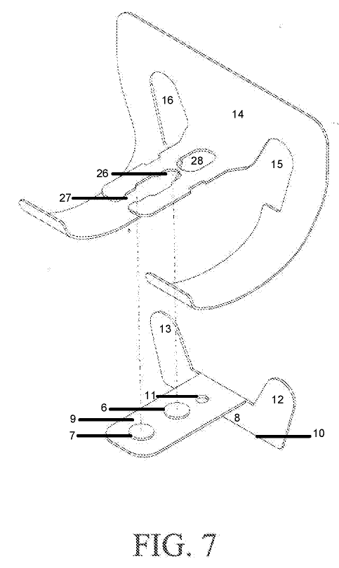

### DETAIL DESCRIPTIONS OF THE INVENTION

All illustrations of the drawings are for the purpose of describing selected versions of the present invention and are not intended to limit the scope of the present invention.

In view of the aforementioned problem(s), the present invention is a tape measure end piece attachment. The present invention retrofits onto the end of a tape measure blade 1 and end hook 8 utilizing the loose rivets 6 and 7 which connect the blade 1 and end hook 8 together. The distal end of the straight tongue's 4 connecting portion 25 is slightly flexible allowing raised rivets 6 and 7 to enter into the tongue's 4 channel 5 and securing the second rivet receiving portion 27 to the second raised rivet 7. while engaging the first rivet 6 and the first rivet receiving portion 26. The device allows measurements of a house roof to be made by from the safety of a ladder without worrying about the blade snagging. Therefore, allowing for exact measurements of an entire roof without getting on said roof. Apart from roof measurements, the present invention is designed for measurements that involve the measuring tape blade traveling over just about any jagged or uneven surfaces. Before explaining at least one embodiment of the present invention in detail, it is to be understood that the device is not limited in its application to the details of the components and arrangements as described or illustrated. The invention is capable of other embodiments and of being utilized and carried out in various ways.

It is also to be understood that the phrasing and terminology employed herein are for the description and should not be regarded as limiting. As such, the present invention is primarily used to measure extended lengths across rough and uneven surfaces, however, the device may be applied to many other settings, situations, and scenarios.

In the preferred embodiment, the present invention is an end piece attachment 29 for a tape measure which attaches onto a tape measure blade 1 and end hook 8. The end hook 8 is an L-shaped piece with a catch portion 10 a space for a third rivet 11 and a connecting portion 9. The connecting portion 9 is orthogonal to the catch portion 10 and mounted onto the top of the tape measure blade 1 by the blade's 1 front end via a first raised rivet 6 and a second raised rivet 7. The first raised rivet 6 and second raised rivet 7 are loosely fixed, allowing for slight height adjustments which allow the end piece attachment 29 to slide onto the top of the end hook 8 and under the raised rivets 6 and 7. The catch portion 10 extends downwards, with respect to the top of the tape measure blade 1. The end hook 8 further comprises a first tab 12 and a second tab 13 each of which extend out of the top of the connecting portion 9 in an upwards direction. The first tab 12 and second tab 13 are used for the purpose of gripping the end hook 8 and inhibiting the blade's 1 end from retracting into the tape measure casing.

In the preferred embodiment of the present invention, the tape measure end piece attachment 29 is a rigid object comprising a large hook 24 a rounded body 3 a connecting body 14 a first tab receiving opening 15 a second tab receiving opening 16 and a straight tongue 4. The rounded bottom 3 and straight tongue 4 extend out of the connecting body 14 forming a single piece of material which make up the end piece attachment 29.

In the preferred embodiment of the present invention, the connecting body 14 comprises a first arm portion 17 and second arm portion 18 and an intermediary portion. The connecting body 14 is thin and relatively straight. The first arm portion 17 is adjacent to the intermediary portion. The intermediary portion is adjacent to the second arm portion 18.

The front part 2 of the large hook can be used for measuring from up against an object and adjusts slightly to compensate for the thickness of the large hook 24

The intermediary portion 14 located in between the first arm portion 17 and second arm portion 18 with the first arm portion 17 and second arm portion 18 being located at opposite ends of the connecting body 14

In the preferred embodiment of the present invention, the rounded body 3 is located below the connecting body 14 comprising a first arched body 21 a second arched body 22 and a slit 23. The first arched body 21 extends from the bottom of the first arm portion 17 curving in a rearward direction. The second arched body 22 extends from the bottom of the second arm portion 18 curving in a rearward direction and mirroring the first arched body 21. The first arched body 21 and second arched body 22 are U-shaped, with their ends pointing upwards. The first arched body 21 and second arched body 22 may be angled outwards slightly at their distal ends, to help keep the attachment moving forward in a straight direction. However, this is not always necessary. The slit 23 traverses centrally through the rounded bottom 3 in between the first arched body 21 and second arched body 22 curving along the shape of the rounded bottom 3. The slit 23 allows extra weight of the present invention's material to be removed to reduce weight. Lighter weight of the end piece attachment 29 eliminates unnecessary stress on the tape measure blade 1 preventing unwanted bending when in use. Furthermore, the lightness of the present invention prevents the end of the tape measure blade 1 from moving unpredictably, allowing users to have more control over both the blade 1 and end piece attachment 29.

In the preferred embodiment of the present invention, the slit 23 extends directly into the first tab receiving opening 15 and second tab receiving opening 16 The most frontward portion of the slit 23 sits in between the bottom of the first tab receiving opening 15 and second tab receiving opening 16. The first tab receiving opening 15 is delineated in between the first arm portion 17 and intermediary portion 19 starting from the top of the first arched body 21 and extending into the intermediary portion 19. The second tab receiving opening 16 is delineated in between the second arm portion 18 and intermediary portion 19 starting from the top of the second arched body 22 and extending into the intermediary portion 19. With this, the second tab receiving opening 16 is a mirror of the first tab receiving opening 15. The first tab receiving opening 15 and second tab receiving opening 16 are shaped to receive the end hook's first tab 12 and second tab 13.

In the preferred embodiment of the present invention, the straight tongue 4 is positioned perpendicularly to the connecting body 14 extending orthogonally near the bottom of the intermediary portion in a rearward direction. The straight tongue 4 serves as an attachment point for the present invention 29 that lays on top of the end hook's 8 connecting portion 9 and engages with the first raised rivet 6 and second raised rivet 7. The straight tongue's 4 position with respect to the bottom of the intermediary portion 19 allows the straight tongue 4 to be retracted into the body of the tape measure case, along with the end of the blade 1 when connected to a tape measure end piece. The straight tongue 4 comprises of a channel 5 with a first rivet receiving portion 26 and a second rivet receiving portion 27. The channel 5 begins at the straight tongue's 4 distal end and extends a short distance towards the connecting body 14. The straight tongue 4 further comprises an opening 28 which is positioned in between the channel 5 and the connecting body 14.

When the present invention is attached onto the tape measure blade 1 and end hook 8 the straight tongue 4 will slide over the top of the tape measure hook's 8 connecting portion 9. When positioned correctly, the first raised rivet 6 will be positioned in the first rivet receiving portion 26 and the second raised rivet 7 will be positioned in the second rivet receiving portion 27. The end hook's first tab 12 and second tab 13 will be disposed within the first tab receiving portion 15 and second tab receiving portion 16 respectively, with the rest of the catch portion 10 disposed within the most frontward portion of the slit 5. With this, the connecting body 14 will be parallel to the catch portion 10 and perpendicular to the tape measure blade 1. The first arched body 21 and second arched body 22 will be positioned below the tape measure blade's 1 underside, acting similar to skis which allow the tape measure's end to be slid along rough and uneven surfaces without snagging or excessive bouncing around, helping to keep the blade 1 and its end travelling forward in a straight direction. These, ski like bottom pieces (arched bottoms) 21 and 22 can be angle and spread to help the attachment to be self-righting and keep the attachment and blade moving in its straight and intended direction.

The end piece attachment 29 will remain secured onto the end hook 8 via engagement with the first raised rivet 6 and second raised rivet 7.

Although the invention has been explained in relation to its preferred embodiment, it is to be understood that many other possible modifications and variations can be made without departing from the spirit of the scope of the invention.

An example of such a modification or variation in keeping with the spirit and scope of the invention is the following:

The first arm portion 17 and the second arm portion 18 can be angled slightly away from the end of the blade 1 starting at the top of the first arm portion 17 and the second arm portion 18 to bring the top part of the first arched body 21 and the second arched body 22 up and out past the end hook 8 allowing the tape measure end piece attachment's 29 rounded bottom 3 to start slightly higher than the bottom of catch portion 10 of the hook 8

What is claimed:

1. A tape measure end piece attachment comprises:
a rounded bottom;
a straight tongue;
a large hook;
the straight tongue comprising of a connecting portion;
the large hook comprising a flat surface;
the straight tongue being positioned perpendicularly to the large hook; and
the straight tongue being positioned tangent to the rounded bottom.

2. The tape measure end piece attachment is made from one piece of material.

3. The tape measure end piece attachment wherein the rounded bottom, the straight tongue, and the large hook are continuously connected.

4. The tape measure end piece attachment comprises,
the rounded bottom comprising an arched body and a slit; and the slit traversing through the arched body.

5. The tape measure end piece attachment comprises,
the slit being positioned under the straight tongue.

6. The tape measure end piece attachment comprises the flat surface of the large hook being flush with the outer lateral surface of the rounded bottom.

7. The tape measure end piece attachment comprises,
the straight tongue having a connecting portion comprising of a channel and two rivet receiving portions for attaching the tape measure end piece attachment to an end hook with two raised rivets made for connecting attachments.

8. A tape measure end piece attachment comprises,
a rounded bottom;
a straight tongue;
a large hook;
the straight tongue comprising a connecting portion with a slot, an opening to accommodate the hooks third rivet and two raised rivet connection sections;
the large hook comprising of a flat surface;
the straight tongue being positioned perpendicularly to the large hook;
the straight tongue being positioned tangent to the larger hook;
the tape measure end piece attachment being made from one piece of material;
the rounded bottom, the straight tongue, and the large hook being continuously connected; and the slot and rivet connection sections running through the straight tongue.

9. The tape measure end piece attachment comprises;
the rounded bottom comprising an arched body and a slit; and
the slit traversing through the arched body.

10. The tape measure end piece attachment comprises;
the slit being positioned under the straight tongue.

11. The tape measure end piece attachment comprises;
the flat surface of the large hook being flush with the outer lateral surface of the rounded bottom.

12. A tape measure end piece attachment comprises;
a rounded bottom;
a straight tongue;
a large hook;
a straight tongue comprising of a connecting portion with a slot and two rivet connection sections and an opening to accommodate for the hooks third rivet;
the straight tongue being positioned perpendicularly to the large hook; and
the straight tongue being positioned tangent to the rounded bottom;
the tape measure end piece attachment being made from one piece of material
the rounded bottom, the straight tongue, and the large hook being continuously connected;
the connecting portion with slot and two rivet connection sections traversing through the middle of the straight tongue and an opening to accommodate the hooks third rivet, the connecting portion allowing the piece to be removed for more precise measurements.
the rounded bottom comprising of an arched body and a slit;
the slit traversing through the arched body; and
the flat surface of the large hook being flush with the outer lateral surface of the rounded bottom;

13. The tape measure end piece attachment comprises;
the slit being positioned under the straight tongue.

14. The tape measure end piece attachment comprises;
a first and second arm position that connects the arched bottom and large hook while creating two tab receiving areas.
